(19) United States
(12) Patent Application Publication
(10) Pub. No.: US 2015/0006376 A1
(43) Pub. Date: Jan. 1, 2015

(54) CONDUCTIVE PAYMENT DEVICE

(71) Applicant: EBAY INC., San Jose, CA (US)

(72) Inventors: Praveen Nuthulapati, San Jose, CA (US); Jeremiah Joseph Akin, Pleasant Hill, CA (US); Kamal Zamer, Austin, TX (US); Jayasree Mekala, Austin, TX (US); Nikhil Vijay Thaker, Austin, TX (US); Joseph Vernon Paulson, San Jose, CA (US)

(21) Appl. No.: 13/929,458

(22) Filed: Jun. 27, 2013

(51) Int. Cl. G06Q 20/34

(52) U.S. Cl. CPC G06Q 20/341
USPC 705/41

(57) ABSTRACT

Systems and methods for providing a payment include determining that a conductive payment device has been positioned immediately adjacent a touch sensitive payment receiving device. A plurality of conductive identification elements that are communicated from the conductive payment device to the touch sensitive payment receiving device are detected and the relative positions of at least some of the plurality of conductive identification elements are determined. User payment account information is then retrieved using the determined relative positions of the at least some of the plurality of conductive identification elements. A payment request is then sent over a network to make a payment using the user payment account information.

### BACKGROUND

1. Field of the Invention

The present invention generally relates to online and/or mobile payments and more particularly to a conductive payment device for making online or mobile payments.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

As discussed above, one type of mobile and online payment device includes a conventional credit card. Conventional credit cards include a magnetic strip upon which payment information is included, and conventional credit card readers are configured to read the payment information on the magnetic strip to retrieve that payment information for use in processing a payment. The use of conventional credit cards with online and mobile payment devices raises a number of issues. For example, the payment information included on the magnetic strip can be erased under a relatively strong magnetic field, rendering the credit card unreadable by credit card readers. Furthermore, conventional credit card readers include a variety of moving parts, making those credit card readers prone to failure. Further still, conventional credit cards are not easily used in online payments, as online payers typically do not have conventional credit card readers that can read the magnetic strip on the credit card to retrieve the payment information, and such users typically must enter the payment information in manually, which is time consuming and error prone.

Thus, there is a need for an improved online and mobile payment device and payment device reading system.

### BRIEF DESCRIPTION OF THE FIGURES

FIG. 1a is a front view illustrating an embodiment of a conductive payment device;

FIG. 1b is a rear view illustrating an embodiment of the conductive payment device of FIG. 1a;

FIG. 1c is a rear view illustrating an embodiment of the conductive payment device of FIG. 1a;

FIG. 2 is a flow chart illustrating an embodiment of a method for providing a payment;

FIG. 3a is a front view illustrating an embodiment of a payment receiving device providing a conductive payment device positioning area;

FIG. 3b is a front view illustrating an embodiment of the conductive payment device of FIGS. 1a, 1b, and/or 1c being provided to a payment receiving device;

FIG. 3c is a side view illustrating an embodiment of the conductive payment device of FIGS. 1a, 1b, and/or 1c being provided to a payment receiving device;

FIG. 3d is a front view illustrating an embodiment of a payment receiving device providing a payment confirmation screen;

FIG. 4 is a front view illustrating a payment receiving device providing a multi-factor authentication screen;

FIG. 5 is a front view illustrating an embodiment of an automated teller machine that operates with conductive identification devices;

FIG. 6 is a perspective view illustrating an embodiment of a ruggedized payment receiving device;

FIG. 7a is a top view illustrating an embodiment of a wearable conductive payment device;

FIG. 7b is a top view illustrating an embodiment of a wearable conductive payment device;

FIG. 8 is a perspective view illustrating an embodiment of a conductive product identification device.

FIG. 9 is a schematic view illustrating an embodiment of a networked system;

FIG. 10 is a perspective view illustrating an embodiment of a payment receiving device;

FIG. 11 is a schematic view illustrating an embodiment of a computer system; and

FIG. 12 is a schematic view illustrating an embodiment of a payment receiving device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for providing payments using conductive payment devices. As discussed in some of the embodiments below, conductive payment cards may be provided to users that are configured to transmit a charge from the user to conductive identification elements embedded in the conductive payment card in a unique sequence based on, for example, their relative positions. The user may then make payments to a merchant or associated payment processor by positioning the conductive payment card adjacent a touch sensitive payment receiving device such as, for example, a touch screen tablet computer. A payment receiving engine in the touch screen tablet computer will then detect the plurality of identification elements on the conductive payment card and determine their relative positions, which as discussed above is a unique sequence and may be used by the payment receiving engine to retrieve user payment account information associated with the user of the conductive payment card. Then, using the user payment account information, the payment processing engine may send a payment request over a network to make a payment using the user payment account. The conductive payment card may also be used for multi-factor authentication when the touch screen tablet computer is configured to receive, for example, passcodes from the user, biometric information from the user, and/or other authentication factors known in the art. Furthermore, rather than provided as cards, the conductive payment devices may be wearable similar to jewelry (e.g., rings, bracelets, etc.), embedded in clothing, and/or as a variety of other wearable articles known in the art.

In other embodiments, rather than being used for payments, the conductive payment cards discussed herein may be used as conductive identification cards that identify the user to a secure system. For example, a bank may provide users with conductive identification cards for use with cash dispensing machines such as automated teller machines (ATMs), which reduces the number of moving parts in those machines needed for conventional magnetic strip identification cards, increasing the life of those machines while reducing the need for maintenance. Furthermore, rather than identifying a user, the conductive identification devices may identify products. For example, conductive identification devices may be affixed to products and positioned adjacent touch screen devices to identify the product to which they are affixed. As discussed further below, providing a conductive identification device on a product may provide a backup identification method when conventional identifiers (e.g., universal product codes (UPCs)) fail.

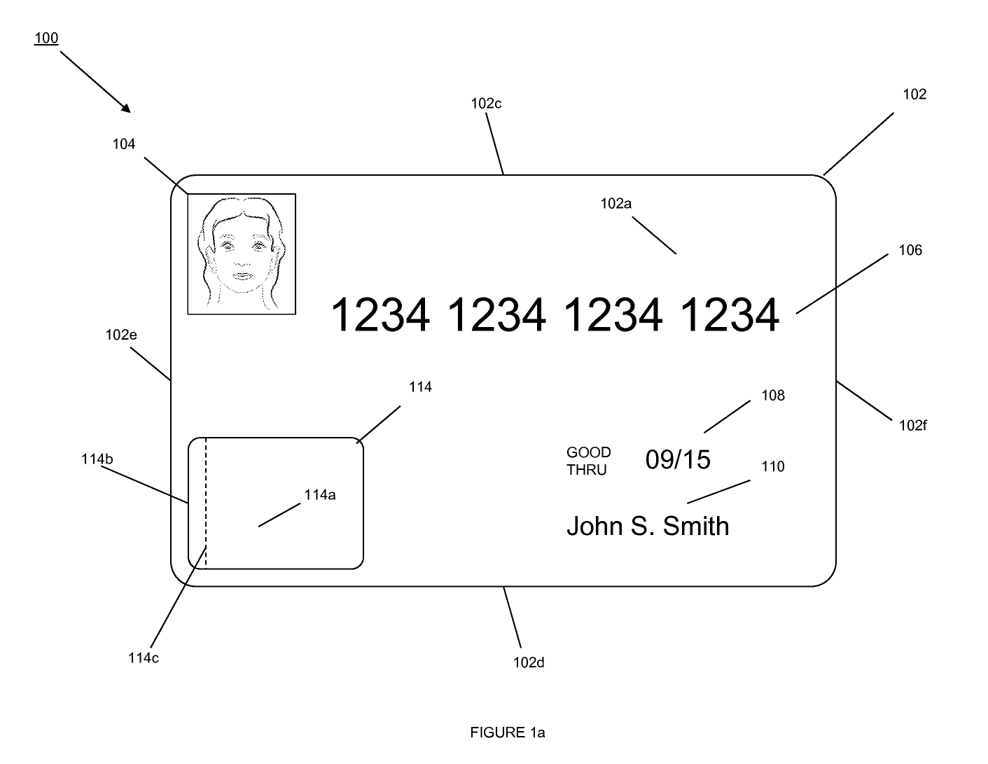

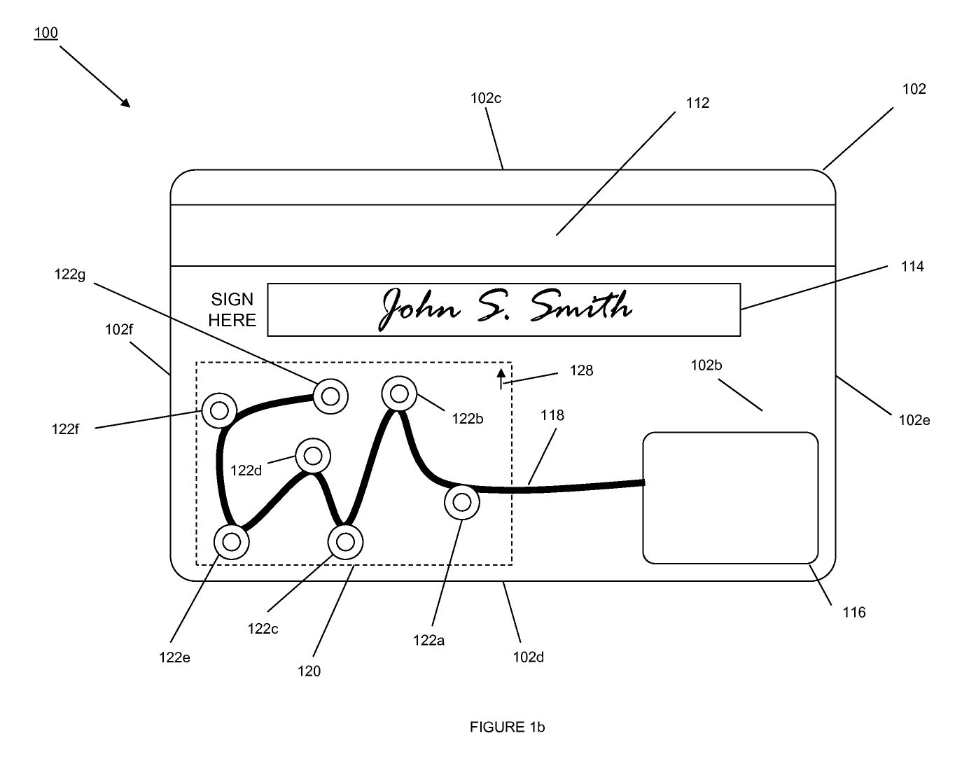

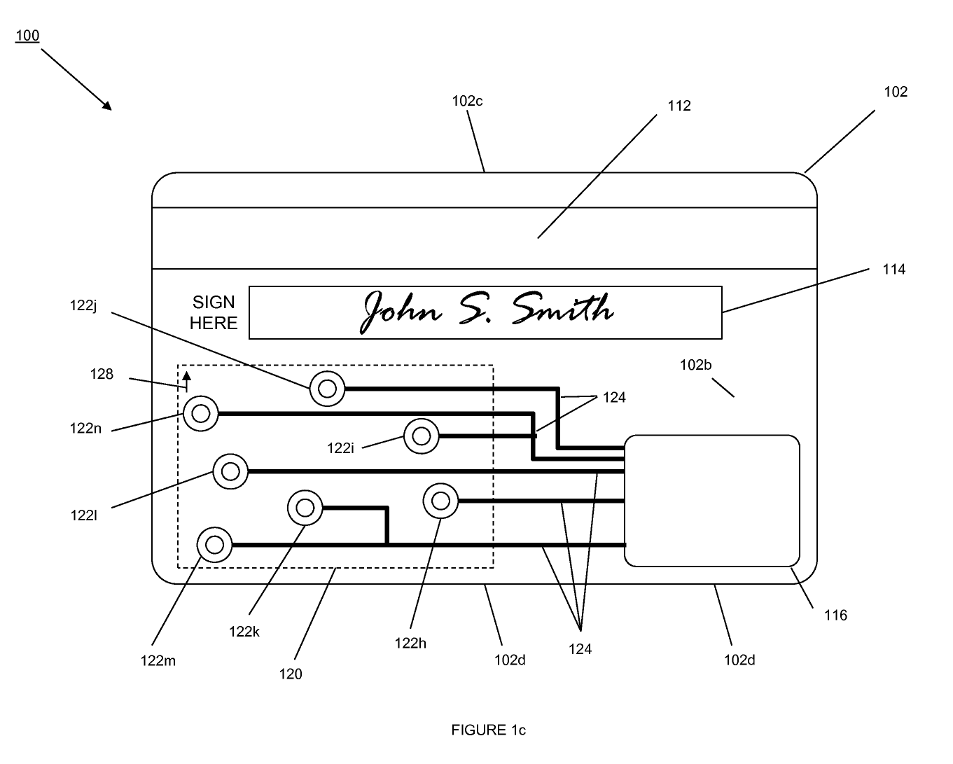

Referring now to FIGS. 1a, 1b, and 1c, an embodiment of a conductive payment device 100 is illustrated. In the examples discussed below, the conductive payment device 100 is payment card made up primarily of a low conductivity plastic, but that includes conductive portions that are configured to conduct a charge from a user holding the card to identification elements that are positioned in a unique sequence on the card that can be used to identify a user account. However, the use of plastic as the low conductivity portion of the conductive payment device 100 is but one of a plurality of low conductivity materials and a card is but one of a plurality of physical manifestations of the conductive payment device 100 that may enable the conductive payments discussed herein. Furthermore, while the conductive payment device 100 is illustrated with dimensions of a conventional credit card or payment card, the conductive payment device may be provided as a smaller dimension cards that, for example, couple to a keychain of a user.

The conductive payment device 100 in the illustrated embodiment includes a card base 102 having a front surface 102a, a rear surface 102b located opposite the card base 102 from the front surface 102a, a top edge 102c extending between the front surface 102a and the rear surface 102b, a bottom edge 102d located opposite the card base 102 from the top edge 102c and extending between the front surface 102a and the rear surface 102b, and a pair of opposing side edges 102e and 102f located opposite the card base 102 from each other and each extending between the front surface 102a, the rear surface 102b, the top edge 102c, and the bottom edge 102d. In an embodiment, the card base 102 is provided using a low conductivity plastic material such as, for example, polyvinyl chloride acetate (PVCA), or a variety of other low conductivity plastic materials known in the art. For example, the card base 102 material may be low conductivity such that it does not conduct a charge from a user's fingers in contact with the low conductivity portions of the card base 102, discussed below.

The conductive payment device 100 may include a variety of conventional payment card features such as, for example, the user image 104 located on the front surface 102a, the user account number 106 located on the front surface 102a, the card expiration date 108 located on the front surface 102a, the user name 110 located on the front surface 102a, the magnetic strip 112 located on the rear surface 102b, and the signature area 114 (including the user signature in the illustrated embodiment) on the rear surface 102b. One of skill in the art will recognize that the conventional payment card features included in the illustrated embodiment are not used for making or receiving payments using the conductive payment device 100, but may be provided such that the conductive payment device 100 may be used with conventional payment systems (or conventional identification systems) when the conductive payment system described herein is unavailable.

While, as discussed above, the card base 102 of the conductive payment device 100 is provided using a low conductivity plastic material, relatively high conductivity portions are provided on the card base 102 to allow a charge to be conducted from a user's fingers in contact with the card base 102 to identification elements arranged in a unique sequence on the card base 102.

In the illustrated embodiment, user contact areas are provided on the card base 102, including a user contact area 114 located on the front surface 102a and a user contact area 116 located on the rear surface 102b. In the illustrated embodiment, the user contact area 114 includes a moveable portion 114a moveably coupled to a secured portion 104b that is secured to the card base 102 and that allows the moveable portion 114a to rotate about an axis 114c relative to the front surface 102a, discussed in further detail below. However, in other embodiments, the user contact area 114 may not be moveable relative to the card base 102.

In an embodiment, the user contact areas may be provided using conductive plastic portions by, for example, impregnating the card base 102 with conductive materials, injecting conductive plastic into an area or areas on the card base 102 during manufacture of the card base 102, etching the card base 102 and filling the etched area with conductive plastic, and/or in any other manner that provides the conductive user contact areas surrounded by the low conductivity card base 102. For example, the user contact areas on the card base 102 may include conductive polymers or carbon nanofibers embedded in the card base 102. In another embodiment, the user contact areas may be provided using other conductive materials such as, for example, metals, metal alloys, foils, graphite, and/or a variety of other conductive materials known in the art, with those conductive materials positioned on the front surface 102a, the rear surface 102b, and/or within the card base 102 to provide the user contact areas 114 and 116. While each of the user contact areas 114 and 116 are illustrated as solid areas, user contact areas may be provided as a grid of conductive material, a point of conductive material, and/or in a variety of other configurations without departing from the scope of the present disclosure.

In the embodiment illustrated in FIG. 1b, a conductive line 118 is provided on the card base 102 and extends from the user contact areas and into an identification element mapping area 120. A plurality of identification elements 122a, 122b, 122c, 122d, 122e, 122f, and 122g are provided on the card base 102 and are located in the identification element mapping area 120 in contact with the conductive line 118. In an embodiment, the conductive line 118 and the plurality of conductive identification elements 122a-122g may be provided using conductive plastic portions by, for example, impregnating the card base 102 with conductive materials, injecting conductive plastic into an area or areas on the card base 102 during manufacture of the card base 102, etching the card base 102 and filling the etched area with conductive plastic, and/or in any other manner that provides the conductive line 118 and the plurality of conductive identification elements 122a-122g surrounded by the low conductivity card base 102. For example, the conductive line 118 and conductive identification elements on the card base 102 may include conductive polymers or carbon nanofibers embedded in the card base 102. In another embodiment, the conductive line 118 and the plurality of conductive identification elements 122a-122g may be provided using other conductive materials such as, for example, metals, metal alloys, foils, graphite, and/or a variety of other conductive materials known in the art, with those conductive materials positioned on the front surface 102a, the rear surface 102b, and/or embedded within the card base 102 to provide the conductive line 118 and the plurality of conductive identification elements 122a-122g. While the conductive line 118 and the plurality of conductive identification elements 122a-122g are illustrated in FIGS. 1a, 1b, 1c as not being visible on the front surface 102a of the card base 102, and being visible on the rear surface 102b of the card base 102b, the conductive line 118 and the plurality of conductive identification elements 122a-122g may be visible on the front surface 102a of the card base 102, not visible on the rear surface 102b of the card base 102, and or not visible on either of the front surface 102a and the rear surface 102b of the card base 102 (e.g., the conductive line 118 and the plurality of conductive identification elements 122a-122g may be embedded within the card base 102.) FIG. 1c illustrates how, rather than having the single conductive line 118 illustrated in FIG. 1b, a plurality of conductive lines 124 may extend between the user contact areas 114 and 116 and conductive identification elements 122h, 122i, 122j, 122k, 122l, 122m, and 122n (e.g., either a single conductive line 124 to a conductive identification element, or a single conductive line 124 to multiple conductive identification elements.)

In an embodiment, the identification element mapping area 120 (e.g., the dashed perimeter defining the identification element mapping area 120) may be provided on the card base 102 using conductive plastic portions by, for example, impregnating the card base 102 with conductive materials, injecting conductive plastic into an area or areas on the card base 102 during manufacture of the card base 102, etching the card base 102 and filling the etched area with conductive plastic, and/or in any other manner that provides the perimeter defining the identification element mapping area 120 surrounded by the low conductivity card base 102. For example, the perimeter defining the identification element mapping area 120 on the card base 102 may include conductive polymers or carbon nanofibers embedded in the card base 102. In another embodiment, the identification element mapping area 120 may be provided using other conductive materials such as, for example, metals, metal alloys, foils, graphite, and/or a variety of other conductive materials known in the art, with those conductive materials positioned on the front surface 102a, the rear surface 102b, and/or embedded within the card base 102 to provide the identification element mapping area 120. While the perimeter defining the identification element mapping area 120 is illustrated in FIGS. 1a, 1b, 1c as not being visible on the front surface 102a of the card base 102, and being visible on the rear surface 102b of the card base 102b, the perimeter defining the identification element mapping area 120 may be visible on the front surface 102a of the card base 102, not visible on the rear surface 102b of the card base 102, and or not visible on either of the front surface 102a and the rear surface 102b of the card base 102 (e.g., the perimeter defining the identification element mapping area 120 may be embedded within the card base 102.) In some embodiments, the identification element mapping area 120 may be conductively coupled to the conductive line 118. In some embodiments, the identification element mapping area 120 may not be provided on the card base 102 using any conductive materials, and may simply be an area of the card base 102 that includes (or is known by a payment receiving engine to include) the conductive identification elements 122-122g or 122h-122n.

In the illustrated embodiment, an orientation element 128 is included in the identification element mapping area 120 and may be conductively coupled to the conductive line 118. The orientation element 128 may be provided on the card base 102 using conductive plastic portions by, for example, impregnating the card base 102 with conductive materials, injecting conductive plastic into an area or areas on the card base 102 during manufacture of the card base 102, etching the card base 102 and filling the etched area with conductive plastic, and/or in any other manner that provides the orientation element 128 surrounded by the low conductivity card base 102. For example, the orientation element 128 on the card base 102 may include conductive polymers or carbon nanofibers embedded in the card base 102. In another embodiment, the orientation element 128 may be provided using other conductive materials such as, for example, metals, metal alloys, foils, graphite, and/or a variety of other conductive materials known in the art, with those conductive materials positioned on the front surface 102a, the rear surface 102b, and/or embedded within the card base 102 to provide the orientation element 128. While the orientation element 128 is illustrated in FIGS. 1a, 1b, 1c as not being visible on the front surface 102a of the card base 102, and being visible on the rear surface 102b of the card base 102b, the orientation element 128 may be visible on the front surface 102a of the card base 102, not visible on the rear surface 102b of the card base 102, and or not visible on either of the front surface 102a and the rear surface 102b of the card base 102 (e.g., the orientation element 128 may be embedded within the card base 102.) As discussed in further detail below, the orientation element 128 may be used by a payment receiving device to determine an orientation of the conductive payment device 100 in order to determine the relative positions of the conductive identification elements so that a user payment account may be retrieved. Thus, while the orientation element 128 is illustrated as an arrow, the orientation element 128 may include any shape or configuration that provides a conductive signature to the payment receiving device that allows the payment receiving device to determine the orientation of the conductive payment device.

In the illustrated embodiment, the conductive identification elements 122a-122g or 122h-122n are illustrated as conductive circles. However, the conductive identification elements 122a-122g or 122h-122n may be provided as other shapes or configurations that may provide a recognizable conductive signature to a touch sensitive payment receiving device, discussed below. Furthermore, different shapes or configurations of conductive identification elements may be used within the identification element mapping area 120 (e.g., the conductive identification element 122a may be a circle, the conductive identification element 122b may be a square, etc.) to provide unique conductive signatures to provide the unique conductive identification element sequence, discussed below. The conductive identification elements 122a-122g or 122h-122n are positioned within the identification element mapping area 120 in locations relative to each other and/or the identification element mapping area 120 in a manner that is unique to the conductive payment device 100. For example, each conductive payment device 100 provided to a particular user may include its conductive identification elements positioned relative to each other and/or the identification element mapping area 120 in a manner that is unique relative to any other conductive payment device issued to any other user. Further still, the number of conductive identification elements provided on the conductive payment device 100 (e.g., in the identification element mapping area 120) may be used along with the relative positions of those conductive identification elements to different conductive payment devices.

In an embodiment, a payment system provider or conductive payment device issuer may provide the conductive payment device 100 to a user by linking a user payment account of the user to a linked payment account identifier, and associating the relative positions (and in some embodiments, the number) of the conductive identification elements on an already-manufactured conductive payment device 100 with the linked payment account identifier. In other embodiments, the payment system provider or conductive payment device issuer may be able to manufacture the conductive payment device 100 “on-the-fly” and position the conductive identification elements on the card base 102 such that their relative positions (and in some embodiments, the number of conductive identification elements) may be translated by payment receiving device into the linked payment account identifier. While a few examples have been provided, one of skill in the art will recognize that a variety of different methods for associating the relative positions of the conductive identification elements (and in some embodiments, the number of conductive identification elements) with a user payment account will fall within the scope of the present disclosure.

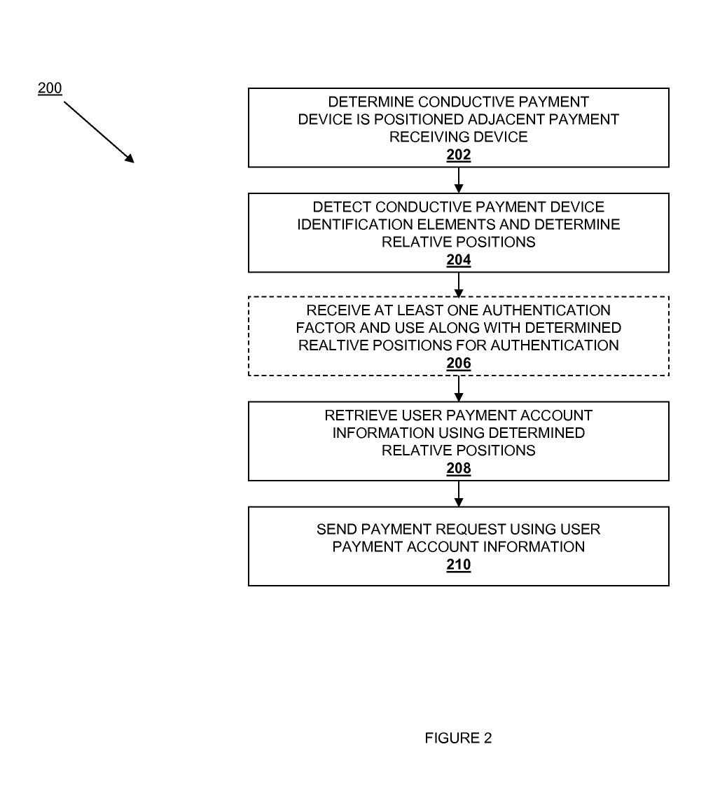

Referring now to FIG. 2, an embodiment of a method 200 for providing payments is illustrated. In an embodiment of the method 200 described below, one or more account providers provide a user with one or more user payment accounts and one or more conductive payment devices associated with those user payment accounts, and the user may use the user payment accounts to fund payments for purchases made from merchants or other payees via the conductive payment devices. In another embodiment, a payment service provider such as, for example, PayPal, Inc. of San Jose, Calif. assists in the making of payments from the user to the merchants or other payees by transferring funds from the user payment account to a merchant account of the merchant. However, these embodiments are meant to be merely exemplary, and one of skill in the art will recognize that a variety of modifications may be made to the payment system discussed below without departing from the scope of the present disclosure.

The method 200 begins at block 202 where it is determined that a conductive payment device is positioned adjacent a payment receiving device. In an embodiment, a merchant may provide the payment receiving device (e.g., at a merchant location where the merchant provides products and/or services for purchase) that includes a touch sensitive display for receiving payment from a user through their conductive payment device. For example, a user may select one or more products and/or services from a merchant at a merchant location prior to block 102 of the method 200. In another embodiment, a user may provide the payment receiving device (e.g., the user may have a personal computer used for making online purchases) that includes a touch sensitive display for making payments using their conductive payment device. For example, a user may select one or more products and/or services from a merchant over a network (e.g., online through the Internet) prior to block 102 of the method 200. While examples of merchant-possession and user-possession of the payment receiving device have been provided, one of skill in the art will recognize that the user may use their conductive payment device with any touch sensitive device including a payment receiving engine or connected to a payment receiving engine over a network.

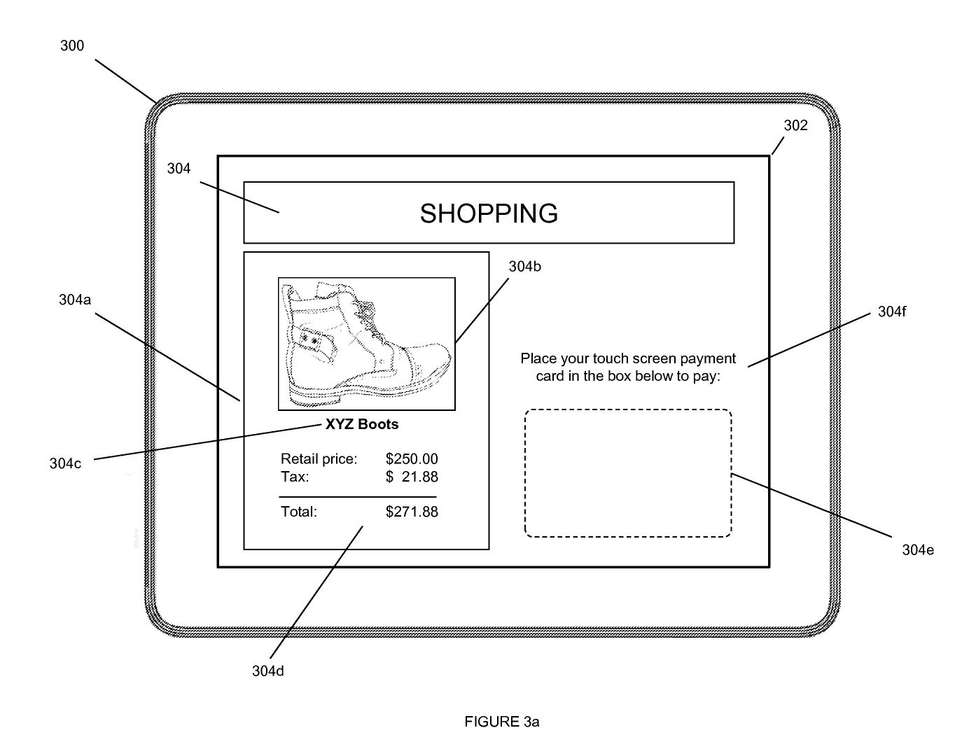

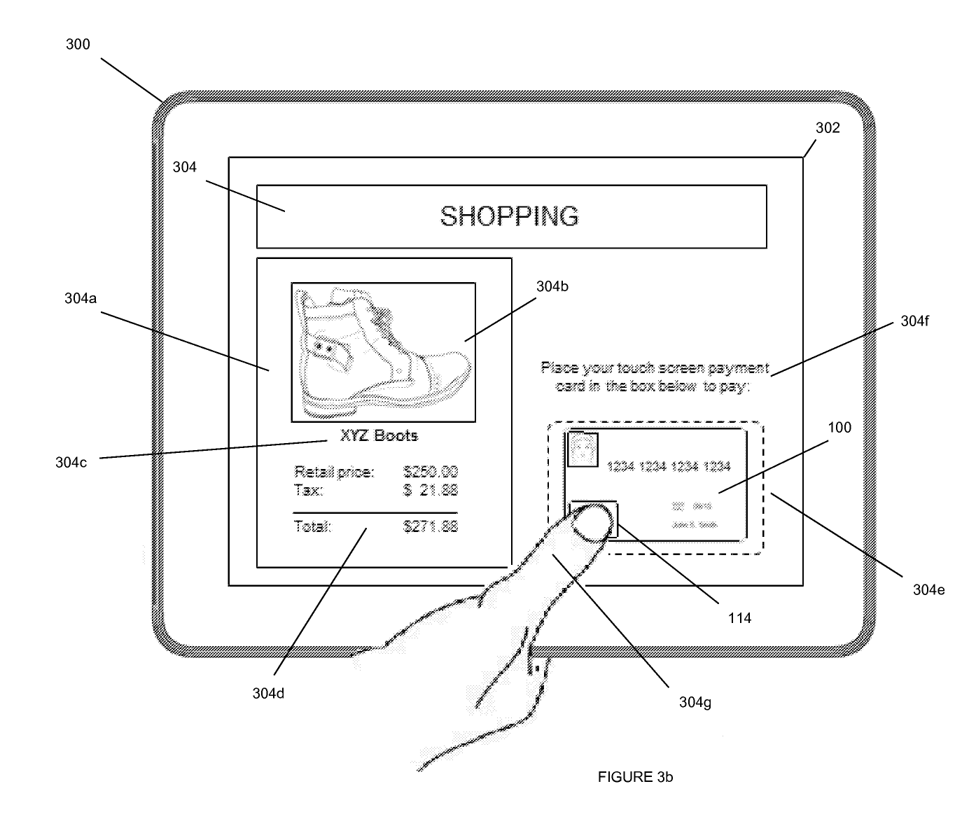

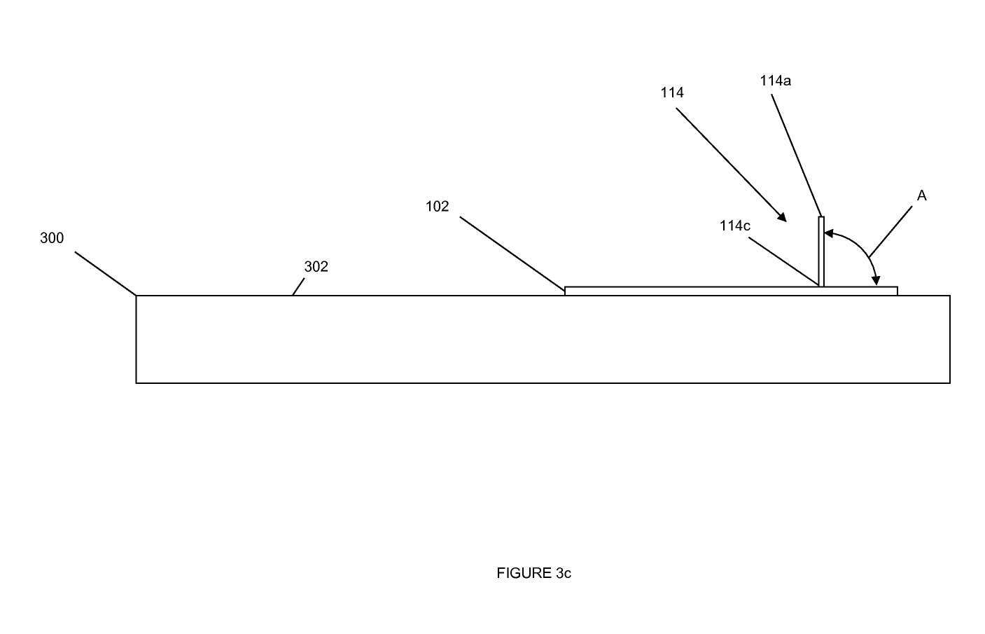

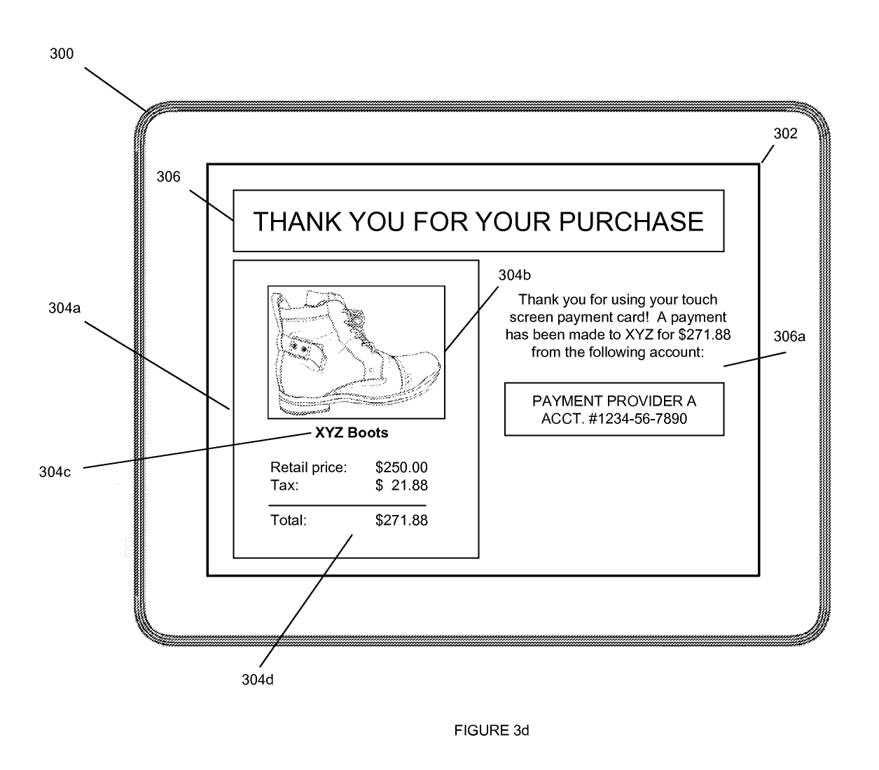

Referring now to FIG. 3a, an embodiment of a payment receiving device 300 is illustrated that includes a touch sensitive display 302 displaying a payment receiving screen 304. In one example, the payment receiving screen 304 may be displayed on a merchant payment receiving device after a user has selected products and/or service from a merchant, and the merchant has provided or read product/service information into the payment receiving device 300 (e.g., by scanning a product/service code associated with the selected product(s)/service(s)). In another example, the payment receiving screen 304 may be displayed on a user payment receiving device after a user has selected products and/or service from a merchant's online website. In the illustrated embodiment, the payment receiving screen 304 includes a product section 304a that includes a product image 304b, a product description 304c, and a plurality of product payment details 304d. While an example of a product section 304a has been provided, one of skill in the art will recognize that a variety of different product (or service) information may be provided about a selected product or service in the product section 304a (e.g., shipping details, etc.) while remaining within the scope of the present disclosure. The payment receiving screen 304 also includes a conductive payment device positioning area 304e along with a positioning instruction 304f that instructs a user to position their conductive payment device (e.g., the conductive payment device 100) adjacent the conductive payment device positioning area 304e to pay for the product displayed on the payment receiving screen 304.

Referring now to FIGS. 1, 3a, and 3b, in an embodiment of block 202, a payment receiving engine coupled to the payment receiving device 300 (e.g., provided as instruction on a memory housed in the payment receiving device 300 that when executed by a processor in the payment receiving device 300 cause the processor to provide the payment receiving engine) determines that the conductive payment device 100 has been positioned immediately adjacent the payment receiving device 300. For example, as illustrated in FIG. 3b, user 304g may position the conductive payment device 100 immediately adjacent the conductive payment device positioning area 304e with the rear surface 102b of the card base 102a engaging the touch sensitive display 302 such that the top edge 102c, the bottom edge 102d, and the side edges 102e and 102f are positioned within the conductive payment device positioning area 304e, and the user (e.g., the user's thumb) is engaging the user contact area 114. With the user engaging the user contact area 114, a charge from the user is conducted from the user contact area 114, through the conductive line 118, and to any or all of the identification element mapping area 120, the plurality of conductive identification elements 122a-122g or 122h-122n, and the orientation element 128. That conducted charge is transmitted to the touch screen display 302 in the conductive payment device positioning area 304e and detected by the payment receiving engine.

Referring now to FIGS. 1a and 3c, in another embodiment, the user 304g may rotate the moveable portion 114a of the user contact area 114 relative to the secured portion 114b about the axis 114c in order to provide the user contact area 114 in a easily graspable configuration for the user 304g to hold and move the card base 102 of the conductive payment device 100 adjacent the payment receiving device 300.

The method 200 then proceeds to block 204 where the conductive payment device identification elements on the conductive payment device are detected and their relative positions (and in some embodiments, the number of conductive identification elements) are determined. While the determination that the conductive payment device is positioned adjacent the payment receiving device and the detection of the conductive payment device identification elements are illustrated as separate method blocks in FIG. 2, those actions may be performed at substantially the same time without departing from the scope of the present disclosure (e.g., the charge transmitted from the conductive payment device 100 to the payment receiving device 300 may be from the conductive payment device identification elements, and that charge may be used to determine that the conductive payment device 100 is positioned adjacent the payment receiving device 300 as well as for detection and determination of the relative positions of the conductive payment device identification elements (and in some embodiments, the number of conductive identification elements).)

Thus, the charge conducted from the user through the user contact area 114, through the conductive line 118, and to the identification element mapping area 120, the plurality of conductive identification elements 122a-122g or 122h-122n, and/or the orientation element 128, and detected by the touch sensitive display 302, is used by the payment receiving engine to determine the relative positions of the conductive identification elements (and in some embodiments, the number of conductive identification elements). In an embodiment, each of the conductive identification elements may be configured to simulate a finger touch of a user on a touch sensitive device such that the touch sensitive device detects a plurality of finger touches (from the conductive identification elements) in a unique, relatively-positioned sequence within the conductive payment device positioning area 304e.

In an embodiment, the payment receiving engine may determine the relative positions of the conductive identification elements (and in some embodiments, the number of conductive identification elements) using only the charge transmitted through those conductive identification elements. For example, a plurality of charge areas or points provided through the conductive identification elements to the touch sensitive display 302 may be used to determine the relative position (and in some embodiments, the number) of those charge areas or points relative to each other (and, thus, the relative positions of the conductive identification elements relative to each other.) In another embodiment, the payment receiving engine may determine the relative positions (and in some embodiments, the number) of the conductive identification elements using the charge transmitted through the conductive identification elements and the identification element mapping area 120. For example, the charge transmitted through the identification element mapping area 120 may be used to determine a perimeter within which a plurality of charge areas or points provided through the conductive identification elements to the touch sensitive display 302 are located, and then the relative position (and in some embodiments, the number) of those charge areas or points relative to each other and/or the identification element mapping area 120 is determined.

In another embodiment, the payment receiving engine may also determine the relative positions of the conductive identification elements using the charge transmitted through the orientation element 128 to determine the orientation of the card base 102 of the conductive payment device 100 before using the charge transmitted from the conductive identification elements and, in some embodiments, the identification element mapping area 120. For example, the charge transmitted through the orientation element 128 may be used to determine the orientation of the card base 102 relative to the payment receiving device 300, and then the charges from the conductive identification elements and, in some embodiments, the identification element mapping area 120, may be used to determine the relative positions (and in some embodiments, the number) of the conductive identification elements based on the orientation of the card base 102. In some embodiments, the charge transmitted from the identification element mapping area 120 may be used to determine the orientation of the card base 102, and the orientation element 128 may be omitted. Furthermore, positioning of the conductive identification elements (and in some embodiments, the number of conductive identification elements) may render the determination of the orientation of the card base 102 unnecessary in some embodiments. In any of those embodiments, the ability to determine the orientation of the conductive payment device allows a user to position the conductive payment device adjacent the payment receiving device in any orientation and still have the conductive identification elements correctly translated to an identifier of a user payment account.

The method 200 includes optional block 206, which is discussed in further detail below. However, the current embodiment of the method 200 proceeds from block 204 to block 208 where user payment account information is retrieved using the determined relative positions (and in some embodiments, the number) of the conductive identification elements. The relative positions (and in some embodiments, the number) of the conductive identification elements on the conductive payment device are unique to that conductive payment device, and correspond to a user payment account of the user that is provided by an account provider, payment service provider, and/or combinations thereof. The relative positions (and in some embodiments, the number) of the conductive identification elements may correspond to a linked account identifier for a user payment account linked to the conductive payment device, to an account number for the user account associated with the conductive payment device, and/or to any other information that may be associated with a user payment account as well as the conductive payment device. Thus, after determining the relative positions (and in some embodiments, the number) of the conductive identification elements at block 204, the payment receiving engine may translate those determined relative positions or that relative position sequence (and in some embodiments, the number of conductive identification elements) to a linked account identifier, an account number, and/or other user payment account identifier, and use it to retrieve user payment account information that describes or identifies the user payment account of the user that is associated with the conductive payment device. In an embodiment, the user payment account information may be retrieved from a user database of associated account identifiers and user payment accounts, over a network, and/or in a variety of other manners and using a variety of other systems known in the art.

Referring now to FIG. 3d, the method 200 then proceeds to block 210 where a payment request is sent using the user payment account information. With the user payment account information retrieved following block 208, the payment receiving engine may send a payment request over a network (e.g., the Internet) to make a payment from the user to the merchant from which the product/service was selected using the user payment account associated with the user payment account information. As is known in the art, the payment request may be accepted or rejected by the account provider or payment service provider, and if accepted the merchant may then provide the products/service purchased to the user. FIG. 3d illustrates a payment confirmation screen 306 that is provided by the payment receiving engine and displayed on the touch sensitive display 302 in response to the payment request being accepted. In the illustrated embodiment, the payment confirmation screen 306 includes the product section 304a discussed above with reference to FIG. 3d, as well as a payment information 306a including details about the payment such as, for example, merchant information, a payment amount, payment provider information, payment account information, and/or a variety of other payment information known in the art. Thus, following block 210 of the method 200, the merchant may provide the product or service purchased (e.g., at the location of the merchant, over the network/Internet, etc.) to the user.

Thus, systems and methods have been described that provide for making and receiving payments using the charge transmitted from a user to a touch sensitive device through a conductive payment card that allows that charge to be provided in a unique sequence that may be associated with a user payment account. The systems and methods described herein allow for payments to be made using conventional touch screen devices that may be provided by merchants or the user making the purchase, and provide benefits over conventional payment device systems that require specialized magnetic card readers or manual entering of user payment account information.

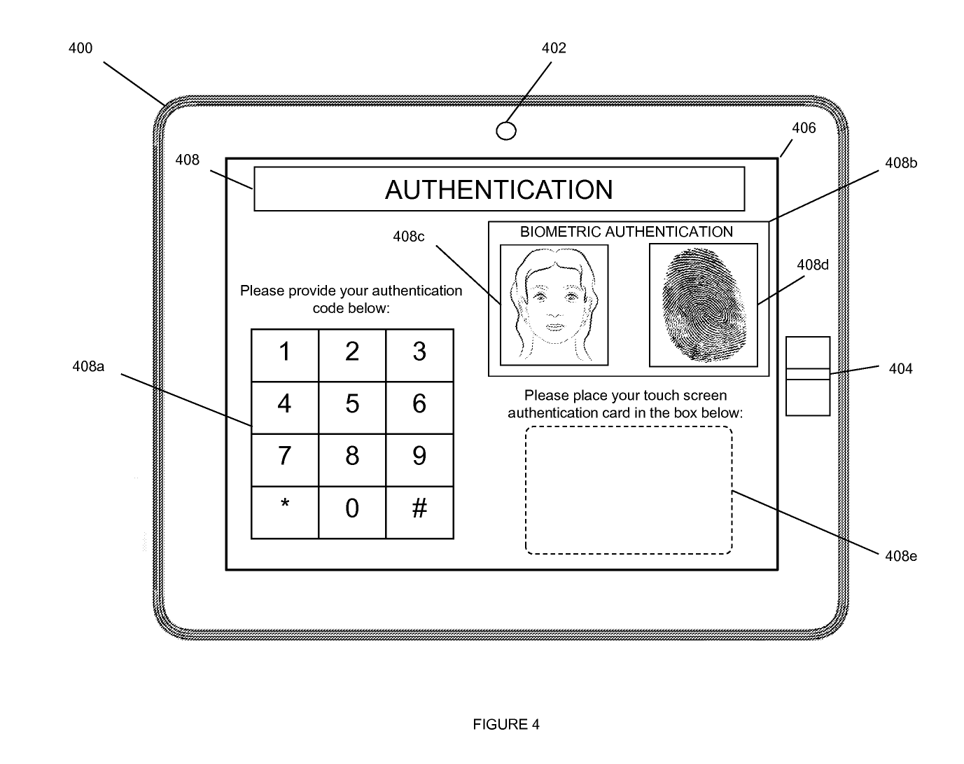

Referring now to FIGS. 1 and 4, an embodiment of optional block 206 of the method 200 is illustrated. At block 206, at least one authentication factor is received and used along with the determined relative positions of the conductive identification elements for authentication. For example, authentication according to optional block 206 may be performed for purchases exceeding a predetermined amount (e.g., $100). In the embodiment illustrated in FIG. 4, a payment receiving device 400 includes a camera 402, a finger print scanning device 404, and a touch screen display 406 (thus, the payment receiving device 400 is substantially similar to the payment receiving device 300, discussed above with reference to FIGS. 3a-3d, but with the addition of the camera 402 and the finger print scanning device 404.) The payment receiving device 400 is displaying a multi-factor authentication screen 408 on the touch screen display 406 that provides for the authentication of the user using multiple authentication factors. In the illustrated embodiment, the multi-factor authentication screen 408 includes a passcode authentication input section 408a that allows a user to input a passcode (e.g., by selecting a sequence of numbers), a biometric authentication section 408b that displays biometric inputs provided by a user (e.g., a facial recognition image 408c taken by the camera 402 and a finger print scan image 408d taken by the finger print scanning device 404), and a conductive payment device positioning area 408e that allows a user to provide their conductive payment card 100 as described above. In some embodiments, rather than using the dedicated finger print scanning device 404, the touch screen display 406 may be operable to recognize a finger print in response to the user engaging the touch screen display 406 with their finger (e.g., the payment receiving engine may provide a finger scan area on the touch screen display 406 for the user to place their finger so that a finger print can be read through the touch screen display 406.) Furthermore, rather than using a numeric keypad in the passcode authentication input section 408a, an input devices with letters (e.g., a keyboard), symbols, any other distinguishing characters, as well as input devices that allow a user to draw a shape or pattern, will fall within the scope of the present disclosure.

Thus, the payment receiving device 400 may receive multiple authentication factors including a passcode, passwords, and/or other information known by the user; facial images, print scans, and/or other information physically unique to the user; and a conductive payment device 100 possessed by the user in order to authenticate the user for making a payment. As such, the payment receiving engine may include facial recognition functionality, finger print analysis functionality, and/or the ability to send facial images and finger print scans over a network for authentication. Furthermore, while the multi-factor authentication has been described according to the method 200 for making and receiving a payment, the payment receiving device 400 may not be used in making payments, but rather may be a dedicated multi-factor authentication device used solely for authenticating users via passcode/password information, biometric information, and conductive identification/authentication devices. Further still, while many factors of authentication are illustrated as being received and used by the payment receiving device 400, conventional two-factor authentication may be enabled by only requiring the user to provide, for example, the passcode information along with the conductive payment device.

The conductive payment device 100 may include a number of additional security features to secure any use of the card to only the actual user. For example, the user image 104 on the conductive payment device 100 may be captured by the camera 402 on the payment receiving device 400 and compared to an actual image of the user also captured by the camera 402. A comparison of those images may be made by the payment receiving engine to determine whether a match exists (e.g., whether the person using the conductive payment device is the person in the user image 104.) In another example, a biometric identifier such user fingerprint information (e.g., received from a previous scan of the users finger) may be included in a biometric identification chip included in the card base 102 (e.g., stored as a binary number on the chip.) The payment receiving engine may retrieve the user finger print information from the biometric identification chip included in the card base 102, and compare that to fingerprint information received from the user through a finger print scanning device or the touch screen display (e.g., convert the finger print received from the user to a binary number and compare that to the binary number for the user finger print information received from the biometric identification chip.) In another example, the conductive identification elements may be provided on the conductive payment device at relative positions and in a unique sequence that represents or is translatable to a biometric identifier of the user (e.g., during manufacture of the conductive payment device, a user fingerprint scan may be taken, and the conductive identification elements may be positioned in the card base 102 based upon that user fingerprint scan.) That biometric identifier may then be associated with a user payment account, and the user may provide the conductive payment card along with their biometric information (e.g., through a finger scan) to both authenticate themselves as the proper user of the conductive payment device, and identify their user account.

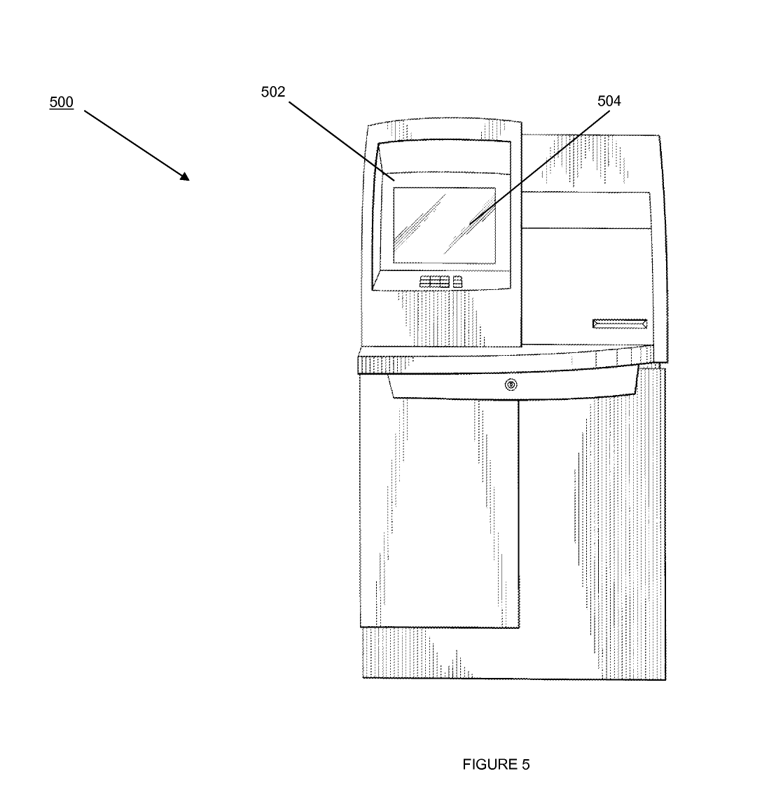

Referring now to FIG. 5, an embodiment of an automated teller machine (ATM) 500 is illustrated that may utilize the systems and methods discussed above with only a slight modification in the purpose of use. As is known in the art, ATMs are used by account providers to provide cash to account holders. The ATM 500 in the illustrated embodiment includes an identification receiving device 502 having a touch sensitive display 504 that is similar to the payment receiving devices 300 and 400 discussed above, but with the provision that they operate with conductive identification devices that identify users for the purpose of dispensing cash rather than with conductive payment cards provided by users for the purpose of making payments. The identification receiving device 502 and touch sensitive display 504 operate substantially as described above for the method 200 to read a conductive identification card provided by a user and determine a user account associated with that conductive identification card, but then function to allow the user to remove cash from the ATM 500 and have that cash debited from the user account, as is known in the art.

In some embodiments, the touch sensitive display 504 may be replaced by a touch sensitive tray upon which the user may place the conductive payment device 100 (e.g., a substantially horizontal surface including the conductive payment device positioning area 304a, which may be provided as a depression in the surface for easy and accurate positioning of the conductive payment device). The use of the identification receiving device 502 and touch sensitive display 504 in place of conventional systems that accept conventional magnetic strip cards reduces the number of moving parts in the ATM 500, while lessening the need for openings in the ATM 500 (to accept the conventional magnetic strip cards) that are vulnerable to water, sand, and other foreign objects, thus extending the life of the ATM and reducing the need for maintenance and repair. Furthermore, the ATM 500 may be provided at a conventional bank drive-throughs, in place of tube systems that are used to physically send bank ID cards, driver licenses, and other user identifying information from the user to the teller, to provide an easy method for providing user information to the teller.

In a similar embodiment, a device similar to the ATM 500 may be used at a drive-through restaurant to accept payment from a customer. For example, a user may order by selecting items for purchase using the touch sensitive display 504, and then pay for those items using a conductive payment card similarly as described above according to the method 200. Such systems and methods deployed at a drive through restaurant operate to reduce lines by allowing quick ordering and accompanied payment through the same device, and require the need for fewer employees, relative to conventional drive through restaurant systems that require the customer order at an ordering station, pay an employee at a pay window, and then pick up food at a food window.

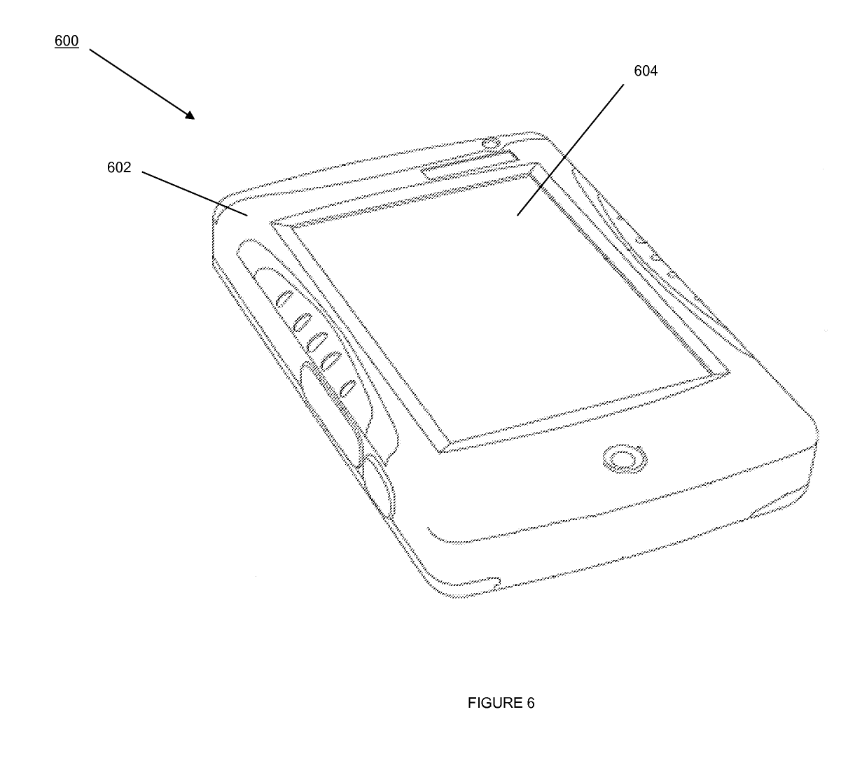

Referring now to FIG. 6, an embodiment of a ruggedized payment receiving device 600 is illustrated that is substantially similar to the payment receiving devices 300 and 400 discussed above, but with the provision of a ruggedized case 602 protecting the payment receiving device while providing access to a touch sensitive display 604. The ruggedized case 602 may be sealed such that it is water-resistant or water-proof, and operates to protect the payment receiving device while allowing payments to be made or received virtually anywhere. For example, the ruggedized payment receiving device 600 may be utilized at a pool or water park (or even underwater) to receive payments from customers. Furthermore, the ruggedized payment receiving device 600 allows for the provision of payments in locations with high humidity and foreign objects (e.g., dirt, sand, etc.) without the worry of system failure or continual maintenance.

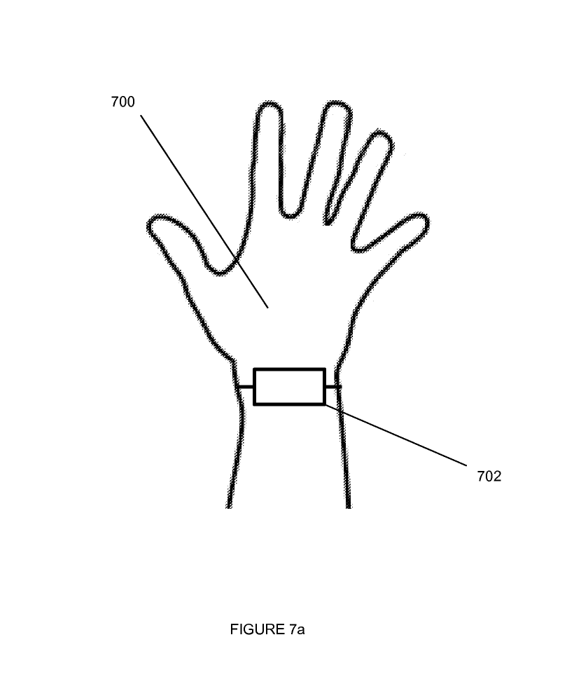

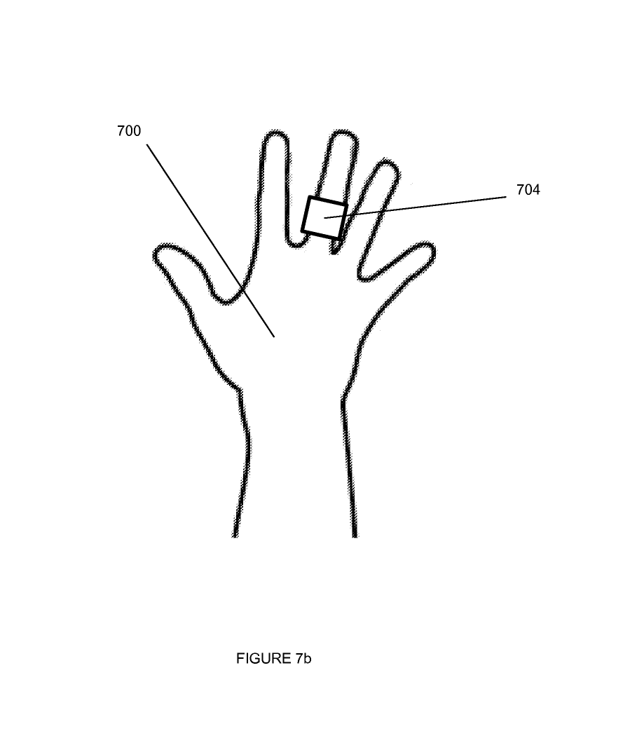

Referring now to FIGS. 7a and 7b, embodiments of wearable conductive payment devices are illustrated. As discussed above, while the conductive payment device 100 is illustrated and described as a card, conductive payment devices may take many forms. FIG. 7a illustrates an embodiment of a user 700 wearing a conductive payment bracelet 702 on their wrist, while FIG. 7b illustrates and embodiment of the user 700 wearing a conductive payment ring 704 on their finger. Each of the conductive payment bracelet 702 and the conductive payment ring 704 may operable substantially as described above for the conductive payment card discussed above, including a user contact area that engages the user (e.g., engaging the back of the wrist in FIG. 7a or the back of the finger in FIG. 7b) and conducts a charge from the user to conductive identification elements housed in the wearable conductive payment device (e.g., in the bracelet 702 or ring 704.)

In one embodiment, wearable conductive payment devices may be associated with user payment accounts and provided to users when they enter a specific place of business. The users may then make purchases by interacting with payment receiving devices using the wearable payment devices, which operate to identify the user and their associated user payment account, authorize payments, and complete transactions. For example, at a theme park, the wearable conductive payment devices may be provided to each member of a family and associated with a user payment account. In some embodiments, the amount that can be spent using any of those wearable conductive payment devices may be limited to predetermined amounts (e.g., a user having the user account may restrict their child's spending via the wearable conductive payment devices to $25/day.) Furthermore, rather than being wearable, a conductive payment device may be included in an accessory, such as a child's toy. For example, a child at the theme park may be given a plastic sword that acts as a conductive payment device (e.g., with a user contact area in the handle, and conductive identification elements in the “blade”) and that can be used with payment receiving devices to make payments.

In another embodiment, the wearable conductive payment devices may be used in a night club. In some examples, wearable conductive payment devices may be linked to user payment accounts (e.g., using an application on a mobile phone) for the duration of the night and only within the night club (e.g., so that purchases cannot be made at any other location other than the night club). In one example, using the conductive payment ring 704 illustrated in FIG. 7b, special movements may be associated with making payments, such as a “fist-bump” to pay that includes the user 700 making a first and then engaging the ring 704 with a touch sensitive display.

In another example, the wearable conductive payment devices provide an ideal payment system for beach resorts, pools, water parks, and other similar areas. For example, providing wearable conductive payment devices such as the bracelet 702 or ring 704 (and in some cases, including spending restrictions, access restrictions, etc.) provide for payment devices that are durable, water-resistant, and generally more child-friendly than conventional payment devices such as cash or credit cards.

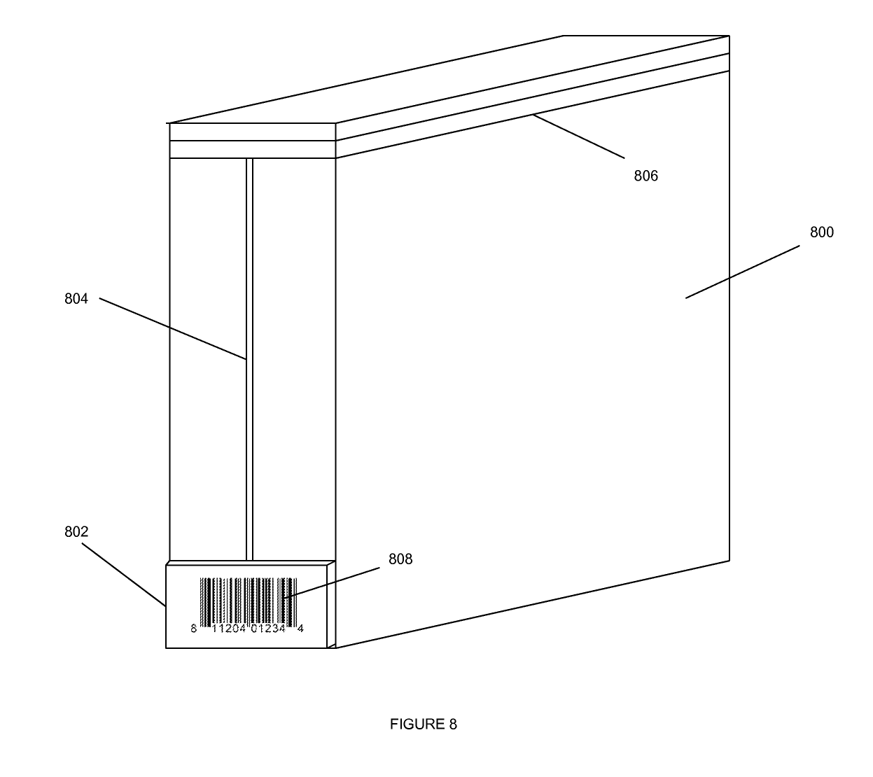

Referring now to FIG. 8, conductive identification devices may be used to identify products so that payments can be made for those products. For example, a product 800 may include a conductive identification device 802 that is connected by a conductive line 804 to a user contact area 806. The conductive identification device 802 includes the conductive identification elements discussed above arranged in a unique sequence that is associated with product details (e.g., description, price, etc.) about the product in a database, and when the conductive identification device 802 is positioned adjacent a touch sensitive device while the user engages the user contact area, a charge from the user is transmitted to through the conductive line 804 to the conductive identification elements in the conductive identification device 802 that allows the product details to be retrieved from the database.

In an embodiment, the conductive identification device 802 may include a product identifier 808 (e.g., a Universal Product Code (UPC)) printed on it or positioned beneath it (e.g., when the conductive identification device 802 and conductive identification elements are transparent) that allows the product 800 to be identified using conventional systems (e.g., via scanning devices). As is known in the art, merchants desire to keep their successful scan rate (i.e., the rate that a scan of the conventional product identifier 808/UPC successfully identifies the product 800) as high as possible. In the event conventional systems for identifying the product 800 via the product identifier 808 do not work, the conducive identification device 802 may be positioned adjacent a touch sensitive device for identification (rather than requiring the cashier to manually input a product identification code.)

The system and methods described herein may be used to provide conductive plastic devices and touch sensitive devices for a variety of other uses as well. For example, touch sensitive devices may be provided for use with video games, and conductive plastic game pieces may be used on those touch sensitive devices to interact with the video game. For example, conductive plastic game pieces may be configured to conduct different amounts of charge from a user so that behavior of video game elements associated with those toys is different. Furthermore, the touch sensitive device may be operable to detect (e.g., via increased charge) when more than one person is touching a conductive plastic game piece, which may be used to start a game, set a number of players in the game, take votes during the game, and/or provide any other video game action known in the art. Conductive plastic game pieces may also include dice with batteries that allow the dice to discharge current, and the use of those dice on the touch sensitive device (with conductive identification elements on each die face) allow the video game to determine what number has been rolled on the dice. In some examples, users may wear a glove that is operable to emit different levels of charge to the touch sensitive device. In other examples, a scarf, shirt, wand, watch, ring, necklace, or other article of clothing may discharge a current through the user, and when the user places the article of clothing or their finger on the touch sensitive device, that charge may be detected.

In another embodiment, the touch sensitive device may be operable to detect the mood of a user based on a transmitted charge, and products/services may be offered depending on the detected mood of the user. For example, a user may be stressed out after a day at work and searching on their tablet computer for a place to eat for dinner. The touch screen display may detect the charges from the user which, based on the stress of the user, will allow an engine in the tablet computer to infer that the user is stressed out. The engine may then be able to, for example, suggest “comfort foods” in a quiet restaurant setting.

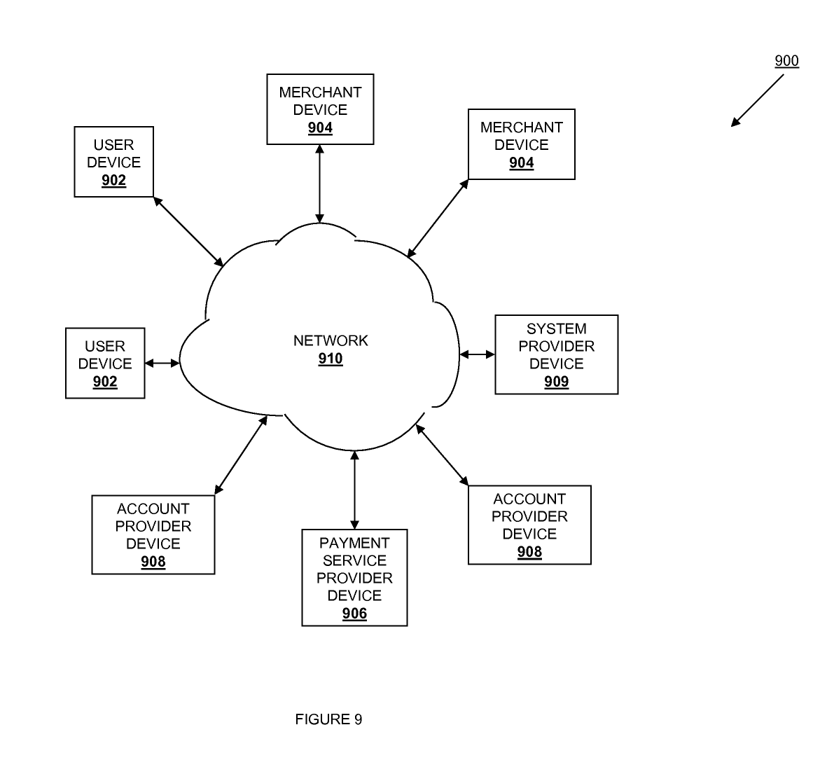

Referring now to FIG. 9, an embodiment of a network-based system 900 for implementing one or more processes described herein is illustrated. As shown, network-based system 900 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 6 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 900 illustrated in FIG. 9 includes a plurality of user devices 902, a plurality of merchant devices 904, a payment service provider device 906, a plurality of account provider devices 908, and/or a system provider device 909 in communication over a network 910. Any of the user devices 902 may be the user payment receiving devices 300 or 400, discussed above. The merchant devices 904 may be the merchant payment receiving devices 300 or 400 discussed above and may be operated by the merchant discussed above. The payment service provider device 906 may be the payment service provider devices discussed above and may be operated by a payment service provider such as, for example, PayPal Inc. of San Jose, Calif. The account provider devices 908 may be the account provider devices discussed above and may be operated by the account providers discussed above such as, for example, credit card account providers, bank account providers, savings account providers, and a variety of other account providers known in the art. The system provider device 909 may be operate by any provider or co-provider of the payment systems described herein.

The user devices 902, merchant devices 904, payment service provider device 906, account provider devices 908, and/or system provider device 909 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 900, and/or accessible over the network 910.

The network 910 may be implemented as a single network or a combination of multiple networks. For example, in various embodiments, the network 910 may include the Internet and/or one or more intranets, landline networks, wireless networks, and/or other appropriate types of networks.

The user devices 902 may be implemented using any appropriate combination of hardware and/or software configured for wired and/or wireless communication over network 910. For example, in one embodiment, the user devices 902 may be implemented as a personal computer of a user in communication with the Internet. In other embodiments, the user device 902 may be a smart phone, personal digital assistant (PDA), laptop computer, tablet computer, and/or other types of computing devices.

The user device 902 may include one or more browser applications which may be used, for example, to provide a convenient interface to permit the user to browse information available over the network 910. For example, in one embodiment, the browser application may be implemented as a web browser configured to view information available over the Internet.

The user device 902 may also include one or more toolbar applications which may be used, for example, to provide user-side processing for performing desired tasks in response to operations selected by the user. In one embodiment, the toolbar application may display a user interface in connection with the browser application.

The user device 902 may further include other applications as may be desired in particular embodiments to provide desired features to the user device 902. In particular, the other applications may include a payment application for payments assisted by a payment service provider through the payment service provider device 906. The other applications may also include security applications for implementing user-side security features, programmatic user applications for interfacing with appropriate application programming interfaces (APIs) over the network 910, or other types of applications. Email and/or text applications may also be included, which allow the user to send and receive emails and/or text messages through the network 910. The user device 902 includes one or more user and/or device identifiers which may be implemented, for example, as operating system registry entries, cookies associated with the browser application, identifiers associated with hardware of the user device 902, or other appropriate identifiers, such as a phone number. In one embodiment, the user identifier may be used by the payment service provider device 906 and/or account provider device 908 to associate the user with a particular account as further described herein.

The merchant device 904 may be maintained, for example, by a conventional or on-line merchant, conventional or digital goods seller, individual seller, and/or application developer offering various products and/or services in exchange for payment to be received conventionally or over the network 910. In this regard, the merchant device 904 may include a database identifying available products and/or services (e.g., collectively referred to as items) which may be made available for viewing and purchase by the user.

The merchant device 904 also includes a checkout application which may be configured to facilitate the purchase by the payer of items. The checkout application may be configured to accept payment information from the user through the user device 902, the account provider through the account provider device 908, and/or from the payment service provider through the payment service provider device 906 over the network 610.

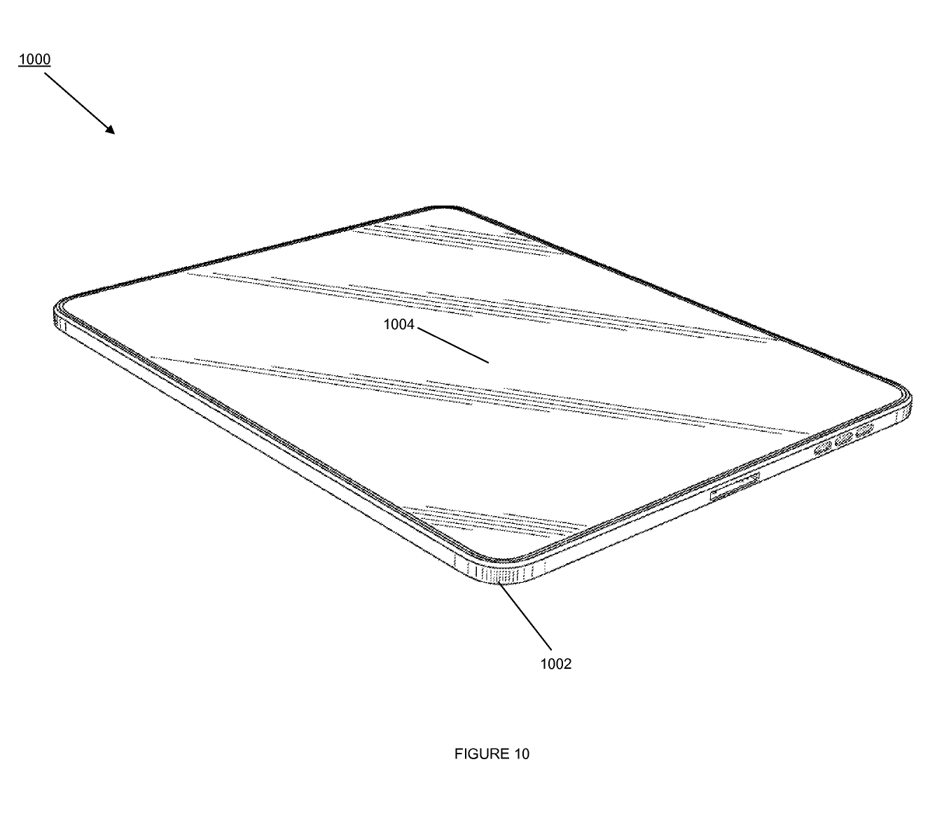

Referring now to FIG. 10, an embodiment of a payment receiving device 1000 is illustrated. The payment receiving device 1000 may be (or be part of) the payment receiving device 300, the authentication receiving device 400, the ATM 500, the ruggedized payment receiving device 600, the user device 902, and/or the merchant device 904. The payment receiving device 1000 includes a chassis 1002 having a touch sensitive display 1004 and may include one or more input devices including the touch sensitive display 1004 and/or a plurality of input button (not illustrated.) One of skill in the art will recognize that the payment receiving device 1000 is a portable or mobile tablet computer including a touch screen input device that allow the functionality discussed above with reference to the method 200. However, a variety of other portable/mobile payer devices and/or desktop payer devices may be used in the method 200 without departing from the scope of the present disclosure.

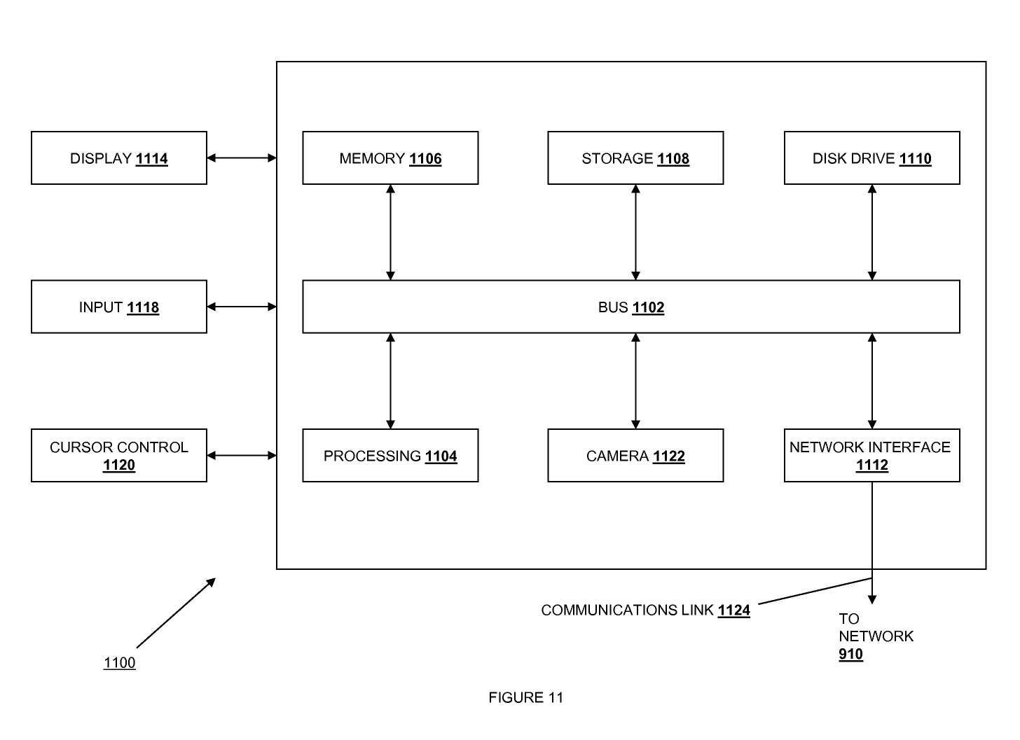

Referring now to FIG. 11, an embodiment of a computer system 1100 suitable for implementing, for example, the payment receiving device 300, the authentication receiving device 400, the ATM 500, the ruggedized payment receiving device 600, the user device 902, and/or the merchant device 904, the payment receiving device 1000, the payment service provider device 606, the account provider device 608, and/or the system provider device 909 is illustrated. It should be appreciated that other devices utilized by users, merchants, payment service providers, account providers, and system providers in the payment system discussed above may be implemented as the computer system 1100 in a manner as follows.

In accordance with various embodiments of the present disclosure, computer system 1100, such as a computer and/or a network server, includes a bus 1102 or other communication mechanism for communicating information, which interconnects subsystems and components, such as a processing component 1104 (e.g., processor, micro-controller, digital signal processor (DSP), etc.), a system memory component 1106 (e.g., RAM), a static storage component 1108 (e.g., ROM), a disk drive component 1110 (e.g., magnetic or optical), a network interface component 1112 (e.g., modem or Ethernet card), a display component 1114 (e.g., CRT or LCD), an input component 1118 (e.g., keyboard, keypad, or virtual keyboard), a cursor control component 1120 (e.g., mouse, pointer, or trackball), and/or a location determination component 1122 (e.g., a Global Positioning System (GPS) device as illustrated, a cell tower triangulation device, and/or a variety of other location determination devices known in the art.) In one implementation, the disk drive component 1110 may comprise a database having one or more disk drive components.

In accordance with embodiments of the present disclosure, the computer system 1100 performs specific operations by the processor 1104 executing one or more sequences of instructions contained in the memory component 1106, such as described herein with respect to the payment receiving device 300, the authentication receiving device 400, the ATM 500, the ruggedized payment receiving device 600, the user device 902, and/or the merchant device 904, the payment receiving device 1000, the payment service provider device 606, the account provider device 608, and/or the system provider device 909. Such instructions may be read into the system memory component 1106 from another computer readable medium, such as the static storage component 1108 or the disk drive component 1110. In other embodiments, hard-wired circuitry may be used in place of or in combination with software instructions to implement the present disclosure.

Logic may be encoded in a computer readable medium, which may refer to any medium that participates in providing instructions to the processor 1104 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1110, volatile media includes dynamic memory, such as the system memory component 1106, and transmission media includes coaxial cables, copper wire, and fiber optics, including wires that comprise the bus 1102. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1100. In various other embodiments of the present disclosure, a plurality of the computer systems 1100 coupled by a communication link 1124 to the network 910 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1100 may transmit and receive messages, data, information and instructions, including one or more programs (i.e., application code) through the communication link 1124 and the network interface component 1112. The network interface component 1112 may include an antenna, either separate or integrated, to enable transmission and reception via the communication link 1124. Received program code may be executed by processor 1104 as received and/or stored in disk drive component 1110 or some other non-volatile storage component for execution.

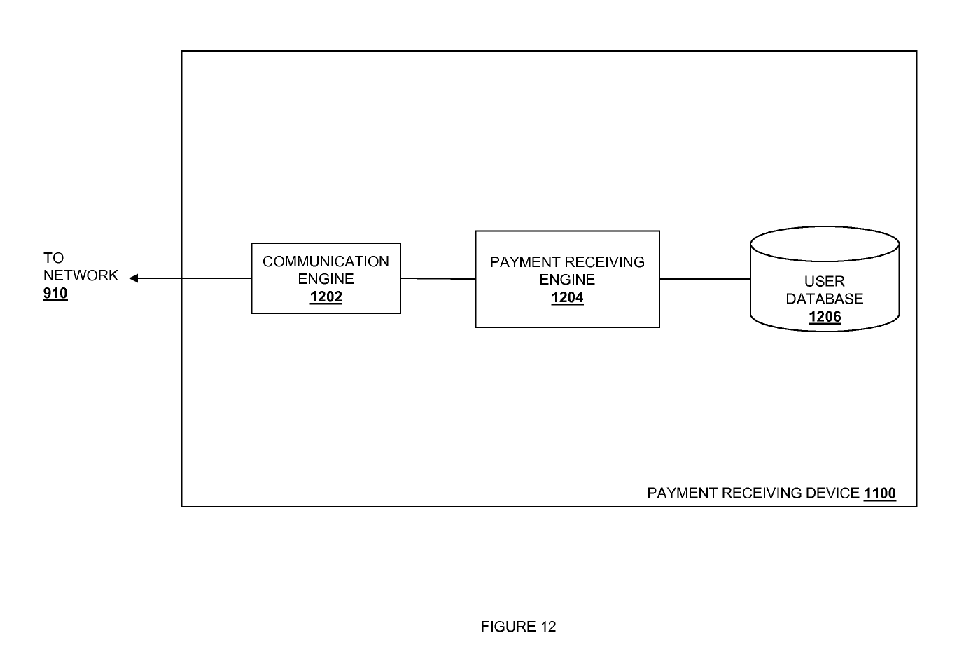

Referring now to FIGS. 12, an embodiment of a payment receiving device 1200 is illustrated. In an embodiment, the device 1200 may be the payment receiving device 300, the authentication receiving device 400, the ATM 500, the ruggedized payment receiving device 600, the user device 902, and/or the merchant device 904. The device 1200 includes a communication engine 1202 that is coupled to the network 910 and to a payment receiving engine 1204 that is coupled to a user database 1206. The communication engine 1202 may be software or instructions stored on a computer-readable medium that allows the device 1200 to send and receive information over the network 910. The payment receiving engine 1204 may be software or instructions stored on a computer-readable medium that is operable to determine conductive payment device are located adjacent the payment receiving device 1200, detect conductive identification elements and determine their relative positions, receive authentication factors, retrieve user payment accounts from the user database 1206 using the determined relative positions of the conductive identification elements, send payment requests, and provide any of the other functionality that is discussed above. While the database 1206 has been illustrated as located in the payment receiving device 1200, one of skill in the art will recognize that it may be connected to the payment receiving engine 1204 through the network 910 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on users and merchants; however, a user or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A payment system, comprising:
a non-transitory memory storing payment receiving engine instructions;
one or more hardware processors coupled to the memory and operable to read the instructions from the memory to perform the steps of:
determining that a conductive payment device has been positioned immediately adjacent a touch sensitive payment receiving device;
detecting a plurality of conductive identification elements communicated from the conductive payment device to the touch sensitive payment receiving device and determining relative positions of at least some of the plurality of conductive identification elements;
retrieving user payment account information using the determined relative positions of the at least some of the plurality of conductive identification elements; and
sending a payment request over a network to make a payment using the user payment account information.

2. The system of claim 1, wherein the one or more hardware processors are further operable to read the instructions from the memory to perform the step of:
displaying, on the touch sensitive payment receiving device, a conductive payment device positioning area, wherein the determining that the conductive payment device has been positioned immediately adjacent the touch sensitive payment receiving device includes determining that the conductive payment device has been positioned immediately adjacent the conductive payment device positioning area.

3. The system of claim 1, wherein the one or more processors are further operable to read the instructions from the memory to perform the steps of:
receiving at least one user authentication factor that includes at least one of user passcode information received from a passcode input device and user biometric information received from a biometric input device; and
using the at least one authentication factor along with the determined relative positions of the at least some of the plurality of conductive identification elements for multi-factor authentication of a user associated with the user payment account information.

4. The system of claim 1, wherein the one or more processors are further operable to read the instructions from the memory to perform the step of:
detecting an orientation element communicated from the conductive payment device to the touch sensitive payment receiving device, wherein the orientation element is used to determine the relative positions of the at least some of the plurality of conductive identification elements.

5. The system of claim 1, wherein the touch sensitive payment receiving device includes a display that is housed in a tablet computer chassis, and wherein the memory and the at least one hardware processor are housed in the tablet computer chassis.

6. The system of claim 1, wherein the detecting the plurality of conductive identification elements communicated from the conductive payment device to the touch sensitive payment receiving device includes detecting a charge passed from a user, through a first conductive area on the conductive payment device, through at least one conductive line on the conductive payment device, and to each of the conductive identification elements.

7. A method for providing a payment, comprising:
determining that a conductive payment device has been positioned immediately adjacent a touch sensitive payment receiving device;
detecting, electronically by a hardware processor, a plurality of conductive identification elements communicated from the conductive payment device to the touch sensitive payment receiving device and determining the relative positions of at least some of the plurality of conductive identification elements;
retrieving user payment account information using the determined relative positions of the at least some of the plurality of conductive identification elements; and
sending a payment request over a network to make a payment using the user payment account information.

8. The method of claim 7, further comprising:
displaying, on the touch sensitive payment receiving device, a conductive payment device positioning area, wherein the determining that the conductive payment device has been positioned immediately adjacent the touch sensitive payment receiving device includes determining that the conductive payment device has been positioned immediately adjacent the conductive payment device positioning area.

9. The method of claim 7, further comprising:
receiving at least one user authentication factor that includes at least one of user passcode information received from a passcode input device and user biometric information received from a biometric input device; and
using the at least one authentication factor along with the determined relative positions of the at least some of the plurality of conductive identification elements for multi-factor authentication of a user associated with the user payment account information.

10. The method of claim 7, further comprising:
detecting an orientation element communicated from the conductive payment device to the touch sensitive payment receiving device, wherein the orientation element is used to determine the relative positions of the at least some of the plurality of conductive identification elements.

11. The method of claim 7, wherein the touch sensitive payment receiving device includes a display that is housed in a tablet computer chassis, and wherein the method is performed by at least one hardware processor that is housed in the tablet computer chassis and that reads instructions for performing the method from a memory that is housed in the tablet computer chassis.

12. The method of claim 7, wherein the detecting the plurality of conductive identification elements communicated from the conductive payment device to the touch sensitive payment receiving device includes detecting a charge passed from a user, through a first conductive area on the conductive payment device, through at least one conductive line on the conductive payment device, and to each of the conductive identification elements.

13. The method of claim 7, wherein the retrieving the user payment account information using the determined relative positions of the at least some of the plurality of conductive identification elements includes translating the determined relative positions into a linked account identifier and using the linked account identifier to retrieve the user payment account information that is associated with a user payment account that is linked to the conductive payment device.

14. A non-transitory machine-readable medium comprising a plurality of machine-readable instructions which, when executed by one or more processors, are adapted to cause the one or more processors to perform a method comprising:
determining that a conductive payment device has been positioned immediately adjacent a touch sensitive payment receiving device;
detecting a plurality of conductive identification elements communicated from the conductive payment device to the touch sensitive payment receiving device and determining the relative positions of at least some of the plurality of conductive identification elements;
retrieving user payment account information using the determined relative positions of the at least some of the plurality of conductive identification elements; and
sending a payment request over a network to make a payment using the user payment account information.

15. The non-transitory machine-readable medium of claim 14, wherein the method further comprises:
displaying, on the touch sensitive payment receiving device, a conductive payment device positioning area, wherein the determining that the conductive payment device has been positioned immediately adjacent the touch sensitive payment receiving device includes determining that the conductive payment device has been positioned immediately adjacent the conductive payment device positioning area.

16. The non-transitory machine-readable medium of claim 14, wherein the method further comprises:
receiving at least one user authentication factor that includes at least one of user passcode information received from a passcode input device and user biometric information received from a biometric input device; and
using the at least one authentication factor along with the determined relative positions of the at least some of the plurality of conductive identification elements for multi-factor authentication of a user associated with the user payment account information.

17. The non-transitory machine-readable medium of claim 14, wherein the method further comprises:
detecting an orientation element communicated from the conductive payment device to the touch sensitive payment receiving device, wherein the orientation element is used to determine the relative positions of the at least some of the plurality of conductive identification elements.

18. The non-transitory machine-readable medium of claim 14, wherein the touch sensitive payment receiving device includes a display that is housed in a tablet computer chassis, and wherein the method is performed by at least one hardware processor that is housed in the tablet computer chassis and that reads instructions for performing the method from the non-transitory machine-readable medium that is housed in the tablet computer chassis.

19. The non-transitory machine-readable medium of claim 14, wherein the detecting the plurality of conductive identification elements communicated from the conductive payment device to the touch sensitive payment receiving device includes detecting a charge passed from a user, through a first conductive area on the conductive payment device, through at least one conductive line on the conductive payment device, and to each of the conductive identification elements.

20. The non-transitory machine-readable medium of claim 14, wherein the retrieving the user payment account information using the determined relative positions of the at least some of the plurality of conductive identification elements includes translating the determined relative positions into a linked account identifier and using the linked account identifier to retrieve the user payment account information that is associated with a user payment account that is linked to the conductive payment device.
